(19) United States
(12) Patent Application Publication
(10) Pub. No.: US 2004/0243267 A1
(43) Pub. Date: Dec. 2, 2004

(54) Systematic control of cross fabrication (fab) engineering changes in integrated circuit (IC) foundry manufacturing

(76) Inventors: Shih-Wen Tu, Hsin-Chu (TW); Gin-Fang Yen, Hsin-Chu (TW); Tze-Chiun Chen, Hsin-Chu (TW); Chie-Ming Yang, Hsin-Chu (TW); Ming-Yu Chuang, Hsin-Chu (TW)

Correspondence Address: TAIWAN SEMICONDUCTOR MANUFACTURING CO., LTD., C/O SLATER & MATSIL, L.L.P., 17950 PRESTON ROAD, SUITE 1000, DALLAS, TX, 75252, US

(21) Appl. No.: 10/448,668

(22) Filed: May 30, 2003

(51) Int. Cl. G06F 19/00

(52) U.S. Cl. 700/105

(57) ABSTRACT

System and method for controlling and propagating engineering changes in integrated circuit manufacturing. A preferred embodiment comprises a technical board (T/B, for example, T/B 220) and a technical database (TTD, for example, TTD 225). The T/B 220 gives permission to an IC fab (for example, IC fab A 205) prior to the IC fab making any changes to a fabrication process. The IC fab then makes an experimental run and reports the results to the T/B 220. The results may then be verified by additional experimental runs at other IC fabs. If the results are acceptable to the T/B 220, a new best known method is created and stored in the TTD 225 and is propagated to other IC fabs if these IC fabs uses the technology relevant to the best known method.

### TECHNICAL FIELD

The present invention relates generally to a system and method for controlling operations of multiple integrated circuit (IC) fabrication lines (fabs), and more particularly to a system and method for controlling and propagating engineering changes across multiple IC fabs to ensure relevant IC fabs are operating with equivalent fabrication techniques and methods.

### BACKGROUND

Generally, when an IC foundry company has multiple IC fab lines, a given IC can be fabricated on one (or more) of the fab lines. For example, if the IC foundry company has a total of ten (10) different IC fab lines, some of these IC fab lines may have similar fabrication technology while others may have different fabrication technologies. For example, if Fab A can make products with feature size from 0.5 um (micron) to 0.25 um; Fab B can make products with feature sizes from 0.8 um to 0.35 um; Fab C can make products with feature sizes from 0.35 um to 0.18 um; then Fabs A, B, and C can be used to make a product with a 0.35 um feature size.

When it comes to producing an IC for a customer, the IC foundry company usually has a choice when it comes to selecting which IC fab line to use. However, if the customer requires a greater production rate than a single IC fab line can sustain, then the IC foundry company may elect to use more than one IC fab line to produce the customer's ICs.

However, when multiple IC fab lines are used to produce a single IC, problems may arise with production. The problems may include (at each of the different IC fab lines): different yields, different reliability rates, different production rates, etc. The problem may stem from the fact that it is likely that the IC fab lines are widely dispersed throughout the region (or country even the world) and it can be difficult to coordinate production across the different IC fab lines. For example, a best known method (BKM) for one IC fab line may not be applicable for another IC fab line, even if the two IC fab lines are capable of making the same product. As a result, one IC fab line may be using a BKM that is different from what the other IC fab lines are using. This may result in ICs made at the one IC fab line have higher (or lower) yields, reliability, production capacity, etc.

In many IC foundry companies, it is rare for an IC fab line to be dedicated to the fabrication of a single type of IC, therefore the majority of IC fab lines can produce a wide variety of ICs using different technologies. Because the technologies can vary widely between IC fab lines, it is common for BKMs for various technologies to propagate within an IC fab and not across multiple IC fabs. Without a centralized method for controlling and propagating changes and tweaks to the BKMs, BKMs for the same technology may differ between IC fab lines. Therefore, each IC fab line (with similar technology) can have widely varying performance, when each should be performing similarly.

One disadvantage of the prior art is that without a centralized controller for approving and propagating changes and tweaks to the BKMs, good changes are slow to propagate to the various IC fab lines, while bad changes can occur without oversight.

A second disadvantage of the prior art is that without a centralized controller, experimentation may be duplicated at several different IC fab lines. Thus effort (and money) is needlessly duplicated and therefore, expended.

A third disadvantage of the prior art is that experience and knowledge is not shared between the different IC fab lines, making it harder and more expensive to bring new IC fab lines into service.

### SUMMARY OF THE INVENTION

These and other problems are generally solved or circumvented, and technical advantages are generally achieved, by preferred embodiments of the present invention which provide a system and method for controlling and propagating changes and tweaks to IC fab lines in an IC foundry company with a plurality of IC fab lines.

In accordance with a preferred embodiment of the present invention, a method to control propagation of engineering changes through a plurality of manufacturing lines comprising approving a proposed engineering change from a manufacturing line, initiating an experimental manufacturing run to test the proposed engineering change, receiving experimental results from the proposed engineering change, accepting the proposed engineering change if the experimental results meet a pre-specified criteria, and distributing the proposed engineering change to applicable manufacturing lines, wherein a manufacturing line is an applicable manufacturing line if the proposed engineering change is for a technology used in the manufacturing line.

In accordance with another preferred embodiment of the present invention, a method for bringing a new manufacturing line on-line comprising obtaining a manufacturing process standard from a centralized source, wherein the manufacturing process standard is for a fabrication technology used by the new manufacturing line, configuring the new manufacturing line according to the manufacturing process standard, and beginning operation of the new manufacturing line

In accordance with another preferred embodiment of the present invention, a system for controlling the propagation of engineering changes comprising a centralized control, the centralized control to make decisions on acceptance and test of proposed engineering changes, a process database coupled to the centralized control, the process database to maintain a process list and accepted engineering changes, and a plurality of manufacturing lines coupled to the centralized control and the process database, each manufacturing line containing manufacturing equipment to produce products according to a process list provided the process database.

An advantage of a preferred embodiment of the present invention is that through a centralized system and method for controlling and propagating changes and tweaks to the IC fab lines, changes can be rapidly propagated to the various applicable IC fab lines and all of the applicable IC fab lines can be brought up to a consistent level across the board.

A further advantage of a preferred embodiment of the present invention is that experimentation can be performed at one or two IC fab lines and the results can evaluated and then provided to the other applicable IC fab lines without them having to perform the experimentation themselves.

Yet another advantage of a preferred embodiment of the present invention is that new IC fab lines can be rapidly brought into production (and at an equivalent performance with existing IC fab lines) by taking all of the knowledge and experience from the other IC fab lines.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawing, in which:

FIG. 1 is a diagram of a simplified view of a relationship between a customer and an integrated circuit (IC) foundry company;

FIG. 2 is a diagram of an IC foundry company's IC fab lines and a prior-art technique for maintaining control of the IC fabs;

FIG. 3 is a flow diagram illustrating an algorithm for use in ensuring the results from IC fabrication runs and experiments are reported to a centralized controller, according to a preferred embodiment of the present invention;

FIG. 4 is a flow diagram illustrating a process for use in controlling and updating fabrication processes across multiple IC fabs, according to a preferred embodiment of the present invention;

FIG. 5 is a flow diagram illustrating a process for use in the propagation of an approved engineering change to various IC fabs, according to a preferred embodiment of the present invention;

FIG. 6 is a flow diagram illustrating a process for use in bringing a new IC fab on-line, according to a preferred embodiment of the present invention; and

FIG. 7 is a diagram illustrating a high-level view of an IC foundry company's IC fabs and a system for controlling and propagating engineering changes to the fabrication process, according to a preferred embodiment of the present invention.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The present invention will be described with respect to preferred embodiments in a specific context, namely an IC foundry company with a plurality of IC fab lines. The invention may also be applied, however, to other manufacturing situations where there are multiple different manufacturing lines that require coordination to maximize efficiency and minimize costs due to undue experimentation and testing. Examples can include circuit board assembly lines, other assembly lines in general, manufacturing lines of other high-tech and low-tech products, etc.

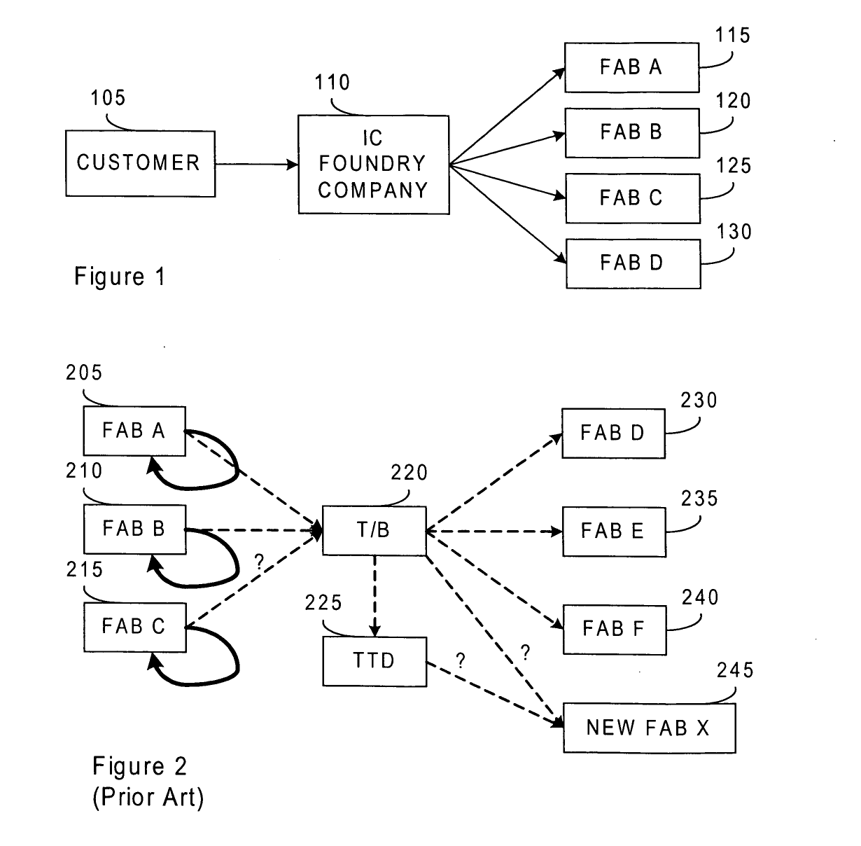

With reference now to FIG. 1, there is shown a diagram illustrating a simplified view of a relationship between a customer 105 and an integrated circuit (IC) foundry company 110 (or simply “the company”), wherein the IC foundry company 110 may have a plurality of different IC fabrication (fab) lines. The customer 105 may contract with the IC foundry company 110 to produce a certain number of ICs using a certain process technology. In the contract, the IC foundry company will typically agree to produce the ICs at a certain rate with a specified yield and reliability rate.

If the contracted production rate is less than what a single IC fab can produce, then the entire production may be produced on a single IC fab (for example, IC fab A 115). If the contracted production rate is greater than the production capacity of a single IC fab, then two or more IC fabs (for example, IC fabs B 120 and C 125) may be required to meet the customer's needs.

Since IC fabs tend to be large and expensive, they tend to be built at different times and are normally located in different facilities and even in different regions of the country (or world). Since the IC fabs were built at different times, the fabrication technology at each IC fab may be different. For example, IC fab A 115 can make products with feature size from 0.5 um to 0.25 um, IC fab B 120 can make products with feature sizes from 0.8 um to 0.35 um, and IC fab C 125 can make products with feature sizes from 0.35 um to 0.18 um. Because the IC fabs typically produce using different technologies and are located at various locations throughout the world, coordinating fabrication processes between the different IC fabs can be difficult. For example, although the IC foundry company 110 may have more than one IC fab lines that are capable of producing ICs using a similar (or same) fabrication process, their being widely separated can make it difficult to produce ICs with similar yields and reliability rates.

This difference in yield and reliability may be the result of tweaks and adjustments (sometimes referred to as engineering changes) made at one IC fab and not at another. For example, a technical manager (or committee) that is responsible for the operations of one IC fab may be more willing to experiment with the fabrication process. All of the experimentation may result in an IC fab with better (or worse) yield and reliability rates. While at an essentially identical IC fab, the technical manager (or committee) may be less adventurous and as a result, this IC fab may have different yield and reliability rates.

The fact that the IC foundry company's different IC fabs may have different yields and reliability rates can be a source of concern for the IC foundry company's customers. For example, the customers may question the IC foundry company's widely varying yield and reliability rates across its various IC fab.

If it is given that the IC foundry company's IC fabs with similar (or identical) capabilities and technologies are used for the fabrication of the ICs, then the various IC fabs should have the similar yield and reliability rates. However, since the IC fabs may be far flung, the IC fabs may often be operated as independent facilities, meaning that experimentation that may take place at the IC fabs can result in different yield and reliability rates. Additionally, the fabrication equipment may slip out of specifications through use and unless they are back into specifications, the yields and reliability rates of ICs made using the out-of-specifications equipment may suffer.

With reference now to FIG. 2, there is shown a diagram illustrating some of an IC foundry company's IC fab lines and a prior-art technique for maintaining control of the IC fabs to ensure that similar IC fabs will have similar yield and reliability rates. As displayed in FIG. 2, the IC foundry company has a total of six IC fabs (numbered 205, 210, 215, 230, 235, and 240) and a new IC fab (new IC fab X 245) that is being brought on-line. Three of the IC fabs (IC fab A 205, IC fab B 210, and IC fab C 215) are either actively producing ICs or running experiments and are designed to provide the results of the fabrication runs and/or experiments to a technical board (T/B) 220. The T/B 220 may be thought of as a centralized controller that is responsible for making technical decisions related to fabrication processes for the company.

The T/B 220 may be a group or committee of personnel, working for the IC foundry company. A purpose of the T/B 220 is to examine the results of the fabrication runs and/or experiments from the various IC fabs and to make a technical determination on the results of the fabrication runs and/or experiments. For example, upon review of the results of an experiment, the T/B 220 may decide that the results of the experiments were positive and that the experiment should be come standard practice for all of the IC foundry company's IC fabs for which the experiment is applicable.

Referring back to the example discussed above, adjustments to a fabrication technique for 0.35 um technology should be propagated to IC fabs A 115, B 120, and C 125; while an adjustment to a fabrication technique for 0.25 um technology should be propagated to IC fabs A 115 and C 125 only since IC fab B 120 does not use that particular technology.

As an alternative, the T/B 220 may be a computer database application or an expert-system. The computer database application or expert-system can be programmed with a wide array of rules related to IC fabrication and would be able to automatically make a decision based on results of the fabrication runs and/or experiments. An advantage of using a computer database application or expert-system is that the T/B 220 can be constantly operating, not having to wait for meetings to convene, as in the case of a T/B comprised of a group or committee of personnel.

However, as shown in FIG. 2, there is no built-in mechanism to ensure that information produced by any of the IC fabs will be delivered to the T/B 220. For example, the results of a fabrication run (or experiment) by IC fab C 215 is not delivered to the T/B 220 (this is shown as a line coupling the IC fab C 215 with the T/B 220 with a question mark). Therefore, the technical knowledge produced by IC fab C 215 is not provided to the T/B 220. The missing information may have a detrimental effect on any decisions made by the T/B 220, since the T/B 220 will not have all of the information that it may need.

The information (results of the fabrication runs and experiments) accumulated in the T/B 220 and then provided to a technology transfer technical database (referred to as a TTD) 225. A function of the TTD 225 is to take the information provided to it by the T/B 220 and to develop a best known method (BKM) to produce different types of ICs. For example, there may be a different BKM to produce 0.25 micron flash memory and a different BKM to produce 0.18 micron CMOS micro-controllers, etc. For each BKM, the TTD 225 produces a process description (a list that steps through the fabrication of an IC and may include other items such as test methodology, machine calibration, etc.). The process description can then be provided to all applicable IC fabs to ensure that each is up-to-date. Note that if an IC fab uses a process technology that is incompatible with the process description, then the process description may not be provided to that particular IC fab.

In addition to bringing existing IC fabs up-to-date, the process descriptions that are produced by the TTD 225 can also be used to rapidly bring new IC fabs on-line. For example, new IC fab X 245 can be provided with an appropriate process description from the TTD 225 and it will immediately be brought up-to-speed with the existing IC fabs. However, as displayed in FIG. 2, with IC fab C 215 not providing its results to the T/B 220, the process description provided to new IC fab X 245 can be of dubious quality since the information used to produce the process may be incomplete.

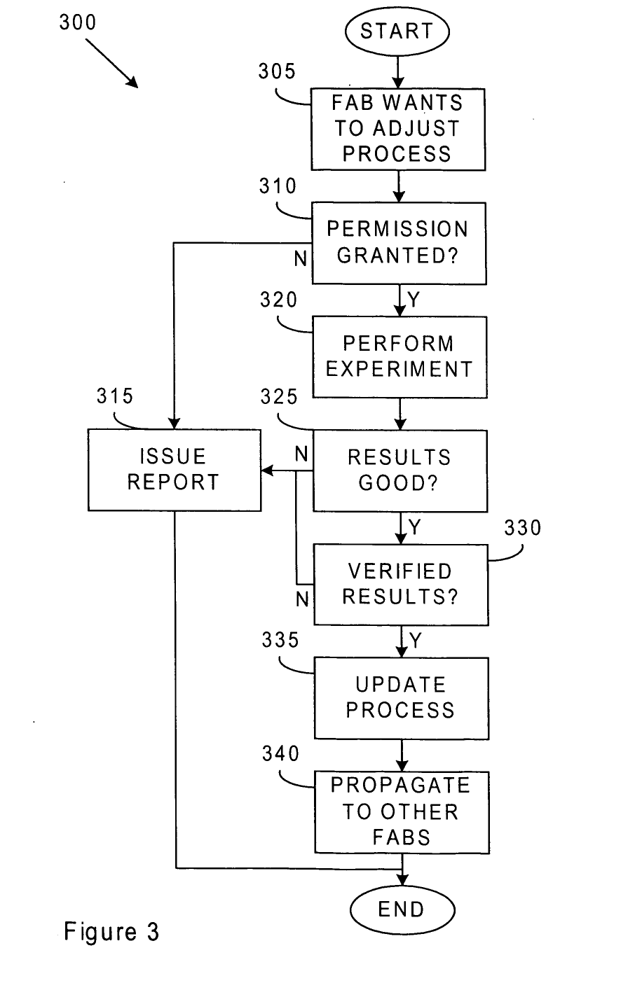

With reference now to FIG. 3, there is displayed a flow diagram illustrating a high-level view of an algorithm 300 to ensure that results from fabrication runs and experiments are reported to a centralized controller (for example, a T/B), according to a preferred embodiment of the present invention. According to a preferred embodiment of the present invention, the algorithm 300 can be implemented by a T/B (for example T/B 220 (FIG. 2)) (when the T/B is a group or committee of personnel of the IC foundry company) or it may actually be executed as a software algorithm executing in a database application or expert system. Should the algorithm 300 be implemented by a T/B that is a committee, a member of the T/B can execute the algorithm 300 through a stand-alone computer, a networked computer, or via a web-page server.

To ensure that the T/B 220 receives the results from all fabrication runs and experiments performed on any of the IC fabs, no such fabrication runs and/or experiments should be performed without having received expressed permission from the T/B 220. This relatively simple interlock mechanism ensures that the T/B 220 knows that a fabrication run (or experiment) is to take place and to expect results from the run. If the T/B 220 does not receive the results in a timely manner, it can readily request the results.

According to a preferred embodiment of the present invention, the T/B 220 begins when it receives a request from an IC fab (block 305) stating that the IC fab wishes to perform a fabrication run, for example, to make an adjustment to the fabrication process, to test a new material, etc. The T/B 220 may decide to grant or deny the request (block 310). The T/B's decision may be based on the nature of the request from the IC fab and other factors, including, but not limited to: the current backlog of ICs that need to be produced, the available manpower to support the fabrication run, etc. If any or all of these factors are not favorable to the request, the T/B 220 may chose to reject the request from the IC fab. If the T/B 220 should chose to reject the request, the T/B 220 may issue a report stating, among other things, the request and its reasons for denying the request (block 315).

If the T/B 220 decides to grant the request, the IC fab is permitted to go ahead with its fabrication run (block 320). Once the IC fab completes its fabrication run, it provides the results back to the T/B 220. The T/B 220 examines the results and decides if the results are good (block 325). If the T/B 220 decides that the results are not good, then the T/B 220 will issue a report stating, among other things, the nature of the fabrication run, the results, and its reasons (if any for deciding that the results were negative).

However, if the T/B 220 decides that the results of the fabrication run by the IC fab was good, then the T/B 220 may decide to repeat the fabrication run to verify the results (block 330). According to a preferred embodiment of the present invention, the verification run should be performed on a different IC fab. This is to ensure that the results were not accidental and that they are repeatable. If the results were not repeatable, the T/B 220 may decide to issue a report stating, among other things, the failure to repeat the results of the fabrication run (block 315). According to a preferred embodiment of the present invention, the T/B 220 may decide to repeat the fabrication run on several IC fabs. The number of IC fabs used to repeat the fabrication run may be dependent on factors such as the number of IC fabs available to perform the fabrication run and the relative importance of the results of the fabrication run (for example, if the results of the fabrication run may save the IC foundry company a considerable amount of money, more IC fabs may be dedicated to the verification fabrication run).

If the verification run verified the results of the initial fabrication run (block 330), the T/B 220 will then update the process for the particular IC (block 335) and then propagate the updated process to applicable IC fabs throughout the IC foundry company (block 340). The propagation of the updated process may be controlled by something as simple as a table, a “technology availability table.” The technology availability table may contain entries that list the various technologies that are used at each IC fab. Then, then a process for a certain technology is updated, the T/B 220 could use the technology availability table to determine which IC fab should receive the updated process. The T/B 220 is then free to process any additional and pending requests from other IC fabs.

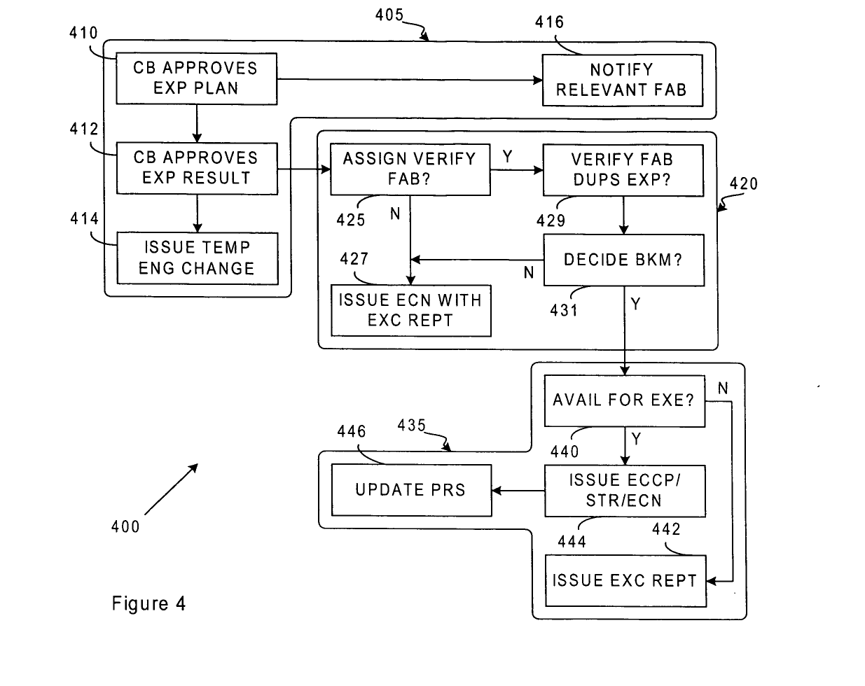

With reference now to FIG. 4, there is shown a diagram illustrating a process 400 for controlling and updating fabrication processes across multiple IC fabs, according to a preferred embodiment of the present invention. The process 400 represents a series of steps that is used to examine, test, and propagate engineering changes (tweaks and changes to the fabrication process) to an IC fabrication process.

The process 400 may be partitioned into three distinct stages: a first stage 405 involves examining a proposed engineering change and an initial fabrication run, a second stage 420 involves examining the results of the initial fabrication run, and a third stage 435 includes updating the BKM and propagating the engineering change to applicable IC fabs.

The first stage 405 involves the examination and approval to test a proposed engineering change to an IC fabrication process and typically occurs at a local level, meaning, the examination and approval to test can occur within a single IC fab. For example, when someone working at a particular IC fab comes up with a possible engineering change to the IC fabrication process, that person can seek to obtain approval to have the proposed engineering change tested at the particular IC fab. Alternatively, the examination and approval may also occur at a company wide level when someone who is not working at a particular IC fab proposes an engineering change and submits it to a technical board (T/B), such as T/B 220 (FIG. 2). The T/B 220 then may decide on the proposed engineering change and uses an available IC fab to test the proposed engineering change.

After an engineering change is proposed, it is examined by an authorized person or committee and then a go-ahead to test the engineering change is either granted or rejected (block 410). If the decision is made at the local level, the authorized person (or committee) may be a change board (CB) of the IC fab and if the decision is made at the company-wide level, then the authorized person (or committee) may be the T/B 220. Note that the CB or T/B may be a computer application, such as a database application or an expert system rather than a person or a group of persons. If the authorized person (either the CB or the T/B, for example) approves the testing of the proposed engineering change, then any and all relevant IC fabs are notified of the testing (block 416). According to a preferred embodiment of the present invention, a relevant IC fab is an IC fab that can make use of the fabrication process that is being modified.

The proposed engineering change to the IC fabrication process is tested by performing an experimental fabrication run and the results are examined by the authorized person. If the results are good, then the authorized person will approve the experimental result (block 412) and then issue a temporary engineering change (TECN) (block 414). A temporary engineering change is issued rather than a permanent engineering change since the results of the experimental fabrication run may be verified through the use of additional experimental fabrication runs at the same (or at different) IC fabs. Until the experimental results have been verified, it is preferred that the engineering change not be made permanent. However, the engineering change process can be configured so that verification of the experimental fabrication runs is not needed. If this is the case, then it is possible for the authorized person (either the CB or the T/B) to issue a permanent engineering change in block 414.

Stage two 420 involves the examination and verification of the results from the initial experimental fabrication run produced in stage one 405. As discussed previously, if the engineering change process has been configured to not require verification, then a significant portion of stage two 420 may be eliminated.

The examination and verification of the experimental results obtained in stage one 405 begins with the assignment of at least one addition IC fabrication run (block 425). Preferably, the addition IC fabrication run(s) are to be performed on IC fab(s) different from the IC fab that performed the initial experimental results. By performing the additional fabrication run(s) on different IC fab(s), the repeatability of the experimental results is tested. After the additional IC fabrication run(s) complete, the results are compared against the initial experimental results (block 429). If the results match, then the T/B (since this is a company-wide decision) will examine the results and decide whether or not to make the proposed engineering change a permanent change to the fabrication process (block 431). The fabrication process is commonly referred to as the Best Known Method (BKM) and is the preferred method for producing an IC using a given process technology.

If the T/B decides to not update the BKM, the T/B will issue an engineering change with an exception report (block 427). Preferably, the exception report will disclose in good detail the proposed engineering change and the experimental results. Along with this information, the T/B may elect to include its reasons for not updating the BKM with the proposed engineering change.

If the T/B decides to update the BKM, then stage three 435 begins. Stage three 435 involves propagating the newly accepted engineering change to the IC fabrication process to other IC fabs that use relevant process technology. According to a preferred embodiment of the present invention, the propagation of the newly accepted engineering change in the form of the updated BKM is provided to only the IC fabs for which the updated BKM is relevant, perhaps selected from entries in a technology available table. Alternatively, the updated BKM may be provided to all IC fabs, and only the IC fabs for which the updated BKM is relevant will make use of the updated BKM.

Stage three 435 begins with the T/B deciding to update the BKM (block 341 of stage two 420). The T/B then checks relevant IC fabs to see if they are ready to make use of the updated BKM (block 440). Alternatively, the T/B may simply check the technology available table to determine which IC fabs should receive the updated BKM. If the IC fabs are not ready to make use of the updated BKM, the T/B will issue an exception report (block 442). The exception report will preferably contain information related to the updated BKM.

If the IC fabs are ready to make use of the updated BKM, the T/B will, in block 444, issue an engineering change control plan (ECCP), a special test request (STR), and an engineering change (ECN) (or a combination of the above). The purpose of the above issued ECCP/STR/ECN is to make changes to the IC fabrication process as a result of the newly accepted engineering change. The T/B will then update the process release standard (PRS) (block 446), which is a record of the whole manufacturing process, including the utilized machinery, process recipe, process parameters, performance measurement specification, etc. In other words, the PRS is a complete specification of how to manufacture an IC using a particular process technology, including how to evaluate and test the end product. The PRS is then provided to relevant IC fabs.

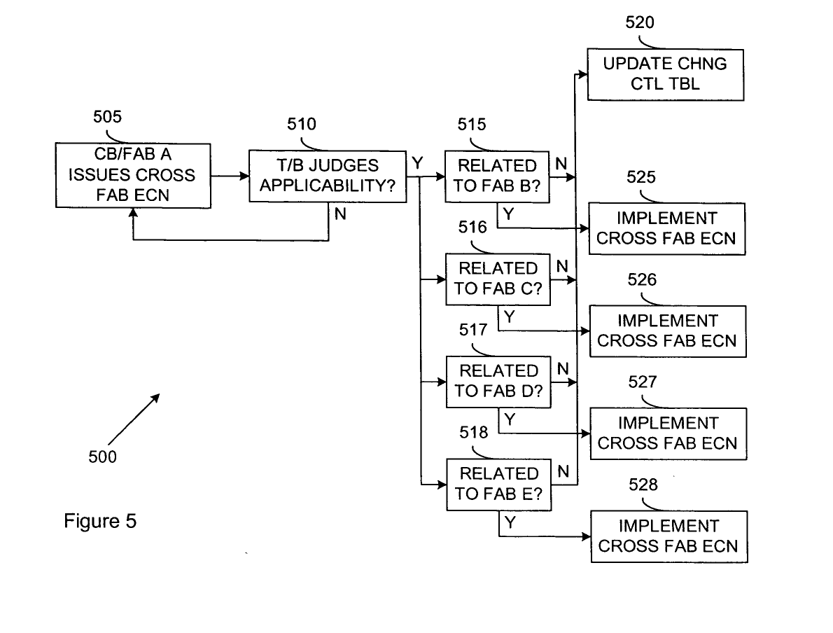

With reference now to FIG. 5, there is shown a diagram illustrating a process 500 for use in the propagation of an engineering change to various IC fabs, according to a preferred embodiment of the present invention. The process 500 illustrates a series of steps used to propagate changes in the fabrication process to relevant IC fabs throughout the company. As an example, the process 400 provides a view of the propagation of an engineering change that originates at an IC fab A.

The process 500 begins in block 505 when the CB of IC fab A issues a cross-fab engineering change. The cross-fab engineering change is an engineering change that may have applicability at other IC fabs in the company, as opposed to a simple engineering change that may be limited in scope only to the IC fab that issues it. After the CB of IC fab issues the cross-fab engineering change, the T/B (since the engineering change affects more than a single IC fab) examines the cross-fab engineering change for applicability to other IC fabs in the company (block 510). Note that the steps illustrated in blocks 505 and 510 may be thought of as simplifications of stages one and two illustrated in FIG. 4.

If the T/B judges that the cross-fab engineering change is not applicable to other IC fabs, the process returns to block 505 to wait for the CB of IC fab A to issue additional cross-fab engineering changes. If the T/B judges that the cross-fab engineering change is applicable to other IC fabs, then the propagation of the engineering change may be as simple as sequentially checking the applicability of the engineering change with each IC fab in the company (for example, block 515 checks for applicability with IC fab B) and then implementing the engineering change (block 525) if it is applicable. If the engineering change is not applicable, then a change control table is updated (block 520). Alternatively, the T/B may have a list (or table) of IC fabs in the company and from the list, the T/B can determine which IC fabs to send the engineering change.

In addition to helping maintain an up-to-date BKM for each of the process technologies used in the company, a preferred embodiment of the present invention can also be used to more rapidly bring a new IC fab on-line. By maintaining a centralized database of BKMs and PRS′, a new IC fab can be made ready to operate in relatively short order. A previously used method may not provide the new IC fab with all of up-to-date information needed; therefore the new IC fab may not be producing ICs optimally for perhaps an extended period of time. This implies that the new IC fab may not be operating at an optimal level.

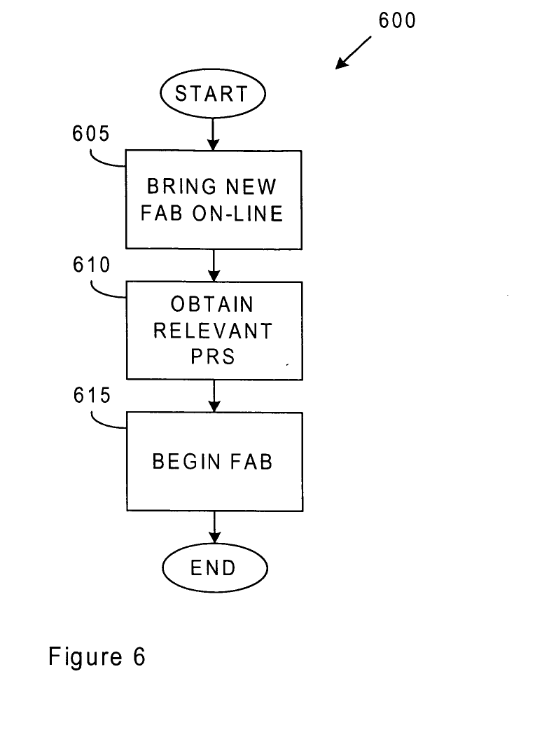

With reference now to FIG. 6, there is shown a diagram illustrating a process 600 used to bring a new IC fab on-line with all the necessary information required to produce ICs, according to a preferred embodiment of the present invention. After the company builds a new IC fab, it is brought on-line as soon as possible (block 605). Once brought on-line, the new IC fab can be provided with all of the relevant BKMs and PRS′ for the appropriate process technologies supported in the new IC fab (block 610). Since the BKM and PRS provided from the central database have been tested and verified, the new IC fab will be able to immediately begin fabrication.

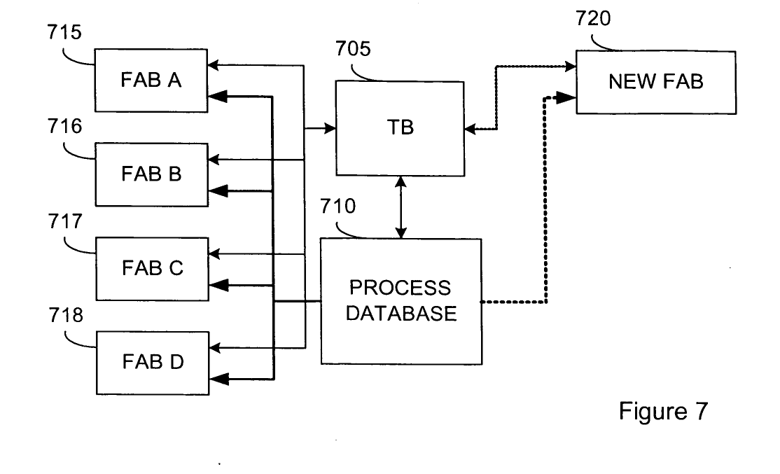

With reference now to FIG. 7, there is shown a diagram illustrating a high-level view of an IC foundry company's IC fabs and a system for controlling and propagating engineering changes to fabrication processes, according to a preferred embodiment of the present invention. The system for controlling and propagating tweaks and changes include a T/B 705 and a process database 710. As discussed earlier, the T/B 705 may actually be a committee of personnel working for the IC foundry company or it may be a computer database application or expert system executing on a computer. The process database 710 can be a place where the various BKMs and PRS′ for the different fabrication processes used at the various IC fabs are stored and maintained. The T/B 705 and process database 710 are coupled via a communications link. Note that if the T/B 705 is a computer database application or an expert system, then the process database 710 may reside in the same computer system as the T/B 705.

The IC foundry company has a plurality of IC fabs (for example, IC fab A 715, and IC fab B 716), with each IC fab coupled to the T/B 705 via a communications link. Preferably, the communications link is a bi-directional link, for example, a private computer network, a public computer network, the Internet, etc. However, to ensure security of the fabrication process information, the communications link should either be private and/or encrypted. Since the communications requirement between the IC fabs and the T/B 705 is not expected to demand a large amount of communications bandwidth, costs can be reduced by sharing a single communications link between all (or some) of the IC fabs. The communications link permits the T/B 705 to exchange information with the IC fabs. Each of the IC fabs is also coupled to the process database 710. Since updates to the fabrication processes are made by the T/B 705, the communications link between the IC fabs and the process database 710 may be unidirectional. The communications links between the T/B 705 and the IC fabs and between the process database 710 and the IC fabs may be shared to further reduce costs.

FIG. 7 also shows a new IC fab 720 being brought on-line. The new IC fab 720 is also coupled to the T/B 705 and the process database 710. While shown as being separate from the remaining IC fabs, FIG. 7 simply displays the new IC fab 720 as being separate. In reality, the new IC fab 720 may share the same communications links with the existing IC fabs and the T/B 705 and the process database 710.

Although the present invention and its advantages have been described in detail, it should be understood that various changes, substitutions and alterations can be made herein without departing from the spirit and scope of the invention as defined by the appended claims.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

1. A method to control propagation of engineering changes through a plurality of manufacturing lines comprising:
approving a proposed engineering change from a manufacturing line;
initiating an experimental manufacturing run to test the proposed engineering change;
receiving experimental results from the proposed engineering change;
accepting the proposed engineering change if the experimental results meet a pre-specified criteria; and
distributing the proposed engineering change to applicable manufacturing lines, wherein a manufacturing line is an applicable manufacturing line if the proposed engineering change is for a technology used in the manufacturing line.

2. The method of claim 1, further comprising after receiving the experimental results, verifying the experimental results.

3. The method of claim 2, wherein the verifying comprises:
initiating an additional experimental manufacturing run to test the proposed engineering change; and
comparing the experimental result with results from the additional experimental manufacturing run.

4. The method of claim 3, wherein the additional experimental manufacturing run is performed on a second manufacturing line, and wherein the second manufacturing line is different from the manufacturing line used to test the proposed engineering change.

5. The method of claim 3, wherein more than one additional experimental manufacturing runs are performed, and each additional experimental manufacturing run is performed on a different manufacturing line.

6. The method of claim 2, wherein the proposed engineering change is accepted if the results of the experimental manufacturing run is essentially similar to the result of the additional experimental manufacturing run.

7. The method of claim 1, wherein the distributing comprises:
updating a manufacturing process to include the proposed engineering change; and
providing the updated manufacturing process to applicable manufacturing lines.

8. The method of claim 1, wherein a table is used to maintain information about fabrication technology used in a manufacturing line.

9. The method of claim 1, wherein the manufacturing line is an integrated circuit (IC) fabrication line.

10. The method of claim 1, wherein the approving is performed by a centralized controller.

11. The method of claim 1, wherein the approving is performed by a controller local to the manufacturing line.

12. The method of claim 11, wherein the accepting and distributing is performed by a centralized controller.

13. A method for bringing a new manufacturing line on-line comprising:
obtaining a manufacturing process standard from a centralized source, wherein the manufacturing process standard is for a fabrication technology used by the new manufacturing line;
configuring the new manufacturing line according to the manufacturing process standard; and
beginning operation of the new manufacturing line, wherein there is more than one type of manufacturing line, and wherein the centralized source maintains manufacturing process standards for each type of manufacturing line.

14. (Cancelled)

15. The method of claim 13, wherein the new manufacturing line is an integrated circuit (IC) fabrication line.

16. The method of claim 13, wherein the new manufacturing line is an integrated circuit (IC) fabrication-line in an IC foundry company with a plurality of IC fabrication lines.

17. A system for controlling the propagation of engineering changes through a plurality of manufacturing lines comprising:
a centralized control, the centralized control to make decisions on acceptance and test of proposed engineering changes;
a process database coupled to the centralized control, the process database to maintain a process list and accepted engineering changes; and
a plurality of manufacturing lines coupled to the centralized control and the process database, each manufacturing line containing manufacturing equipment to produce products according to a process list provided by the process database.

18. The system of claim 17, wherein the centralized control is a group of personnel.

19. The system of claim 17, wherein the centralized control is a computer application.

20. The system of claim 19, wherein the process database resides with the centralized control in one computer system.

21. The system of claim 17, wherein a manufacturing line submits an engineering change to the centralized control for acceptance, wherein the centralized control accepts the engineering change after the engineering change is tested and verified, wherein the accepted engineering change is used to modify a process list stored in the process database, wherein the modified process list is distributed to applicable manufacturing lines, and wherein a manufacturing line is an applicable manufacturing line if the proposed engineering change is for a technology used in the manufacturing line.

22. The system of claim 17, wherein the centralized control, process database, and plurality of manufacturing lines are coupled via a communications link.

23. The system of claim 17, wherein the manufacturing lines are integrated circuit (IC) fabrication lines.
